(19) United States
(12) Patent Application Publication
(10) Pub. No.: US 2025/0182128 A1
(43) Pub. Date: Jun. 5, 2025

(54) GENERATING TRAINING DATA FROM SCENARIO DRIVEN SIMULATED USERS

(71) Applicant: Scaled Cognition, Inc., Amesbury, MA (US)

(72) Inventors: Dan Klein, Berkeley, CA (US); Mathew Gardner, Irvine, CA (US); Emmanouil Antonios Platanios, Fremont, CA (US); Mitchell Stern, Berkeley, CA (US); Adam Pauls, Berkeley, CA (US)

(73) Assignee: Scaled Cognition, Inc., Amesbury, MA (US)

(21) Appl. No.: 18/527,369

(22) Filed: Dec. 4, 2023

(51) Int. Cl. G06Q 30/01; H04L 51/02

(52) U.S. Cl. CPC G06Q 30/01; H04L 51/02

(57) ABSTRACT

A system that generates relevant and vetted training data using intelligent simulated users and evaluation of conversation data. A simulated user and an automated agent engage in a conversation to generate conversation and/or interaction data. The simulated user is guided by scenarios which are generated based on one or more controls to be followed by the automated agent. Using a simulated user driven by control-derived scenarios ensures the ensuing conversation data is relevant to the desired scope of operation for the automated agent. The conversation data is evaluated based on the controls to confirm the automated agent actions and responses followed the controls properly. Evaluating the conversation data based on the controls ensures that conversation data associated with properly followed controls is used as subsequent training data.

### BACKGROUND

Customer service assistant applications are becoming more common and adept at assisting customers with their needs. The customer service applications often interact with a customer through a chat application, in which the agent and customer may exchange text messages with each other. In a typical exchange, a customer begins by entering an inquiry into a chat application. The customer service assistant application receives and processes the inquiry, generates a response, and transmits the response to the user.

Proper training of a customer service assistant application requires large amounts of training data. To be useful, training data should be relevant, and thereby pertain to what the automated agent is supposed to achieve. Further, training data should be vetted to confirm that it reinforces proper behavior. To generate both relevant and vetted training data requires a large amount of time for engineers and administrators. What is needed is an improved customer service assistant.

### SUMMARY

The present technology, roughly described, generates relevant and vetted training data using intelligent simulated users and evaluation of conversation data. A simulated user and an automated agent engage in a conversation to generate conversation and/or interaction data. The simulated user is guided by scenarios which are generated based on one or more controls to be followed by the automated agent. Using a simulated user driven by control-derived scenarios ensures the ensuing conversation data is relevant to the desired scope of operation for the automated agent. The conversation data is evaluated based on the controls to confirm the automated agent actions and responses followed the controls properly. Evaluating the conversation data based on the controls ensures that conversation data associated with properly followed controls is used as subsequent training data.

In operation, the controls that an automated agent are to follow, which may include rules and/or instructions, are accessed. Scenarios are then generated from the controls. In some instances, a scenario may be generated by a large language model that is tasked with generating scenarios based on each of one or more controls. The scenarios may comprise different sets of factors, variables, and state data to test an automated agent's compliance with the particular control.

Once the scenarios are generated, an automated agent and a simulated user are initiated with the scenarios and initial state data. The initial state data may include background information as to a simulated state that exists as the automated agent and simulated user begin their interaction. A conversation, exchange, or interaction between the automated agent and simulated user then occurs and is evaluated to determine if the controls were followed by the automated agent during the conversation. When an automated agent is determined to have properly followed a control during a conversation, the automated agent actions and conversation data are saved as a verified example and stored as training data. When an automated agent is determined to have not properly followed a control, the agent's actions and conversation data are stored in a failed pool, and the data not used as training data.

In some instances, the present technology performs a method for generating training data using a simulated user. The method begins with generating one or more scenarios by a first application on a first server based on a control. A simulated user is provided based on the scenario, wherein the simulated user is provided by a simulated user application. An example of an interaction between an automated agent and the simulated user is accessed by the first application. Each example is associated with an action by the automated agent and includes a subset of the interaction. The example is then selected as training data for a subsequent learning process based on whether the automated agent action in the example is validated to be proper based on the control.

In some instances, the present technology includes a non-transitory computer readable storage medium having embodied thereon a program, the program being executable by a processor to method for generating training data using a simulated user. The method begins with generating one or more scenarios by a first application on a first server based on a control. A simulated user is provided based on the scenario, wherein the simulated user is provided by a simulated user application. An example of an interaction between an automated agent and the simulated user is accessed by the first application. Each example is associated with an action by the automated agent and includes a subset of the interaction. The example is then selected as training data for a subsequent learning process based on whether the automated agent action in the example is validated to be proper based on the control.

In some instances, the present technology includes a system having one or more servers, each including memory and a processor. One or more modules are stored in the memory and executed by one or more of the processors to generate one or more scenarios by a first application on a first server based on a control, provide a simulated user based on the scenario, the simulated user provided by a simulated user application, access an example of an interaction between an automated agent and the simulated users by the first application, wherein each example is associated with an action by the automated agent, wherein the action is associated with the control, wherein the example including a subset of the interaction, and select the example as training data for a subsequent learning process based on whether the automated agent action in the example is validated to be proper based on the control.

### BRIEF DESCRIPTION OF FIGURES

FIG. 1 is a system for providing an intelligent simulated user for generating training data.

FIG. 2 is a system for providing another intelligent simulated user for generating training data.

FIG. 3 is a block diagram of an automated agent application.

FIG. 4 is a block diagram of a conversation manager.

FIG. 5 illustrates data flow for a machine learning model.

FIG. 6 illustrates how training data is generated from controls using the present system.

FIG. 7 is a method for intelligently generating training data using a simulated user.

FIG. 8 is a method for generating a scenario to be tested.

FIG. 9 is a method for initializing an automated agent and simulated user.

FIG. 10 is a method for conducting a conversation between a simulated user and an automated agent.

FIG. 11 is a method for automatically evaluating automated agent behavior to produce training data.

FIG. 12 is a block diagram of a system for implementing the present technology.

### DETAILED DESCRIPTION

The present technology, roughly described, generates relevant and vetted training data using intelligent simulated users and evaluation of conversation data. A simulated user and an automated agent engage in a conversation to generate conversation and/or interaction data. The simulated user is guided by scenarios which are generated based on one or more controls to be followed by the automated agent. Using a simulated user driven by control-derived scenarios ensures the ensuing conversation data is relevant to the desired scope of operation for the automated agent. The conversation data is evaluated based on the controls to confirm the automated agent actions and responses followed the controls properly. Evaluating the conversation data based on the controls ensures that conversation data associated with properly followed controls is used as subsequent training data.

In operation, the controls that an automated agent are to follow, which may include rules and/or instructions, are accessed. Scenarios are then generated from the controls. In some instances, a scenario may be generated by a large language model that is tasked with generating scenarios based on each of one or more controls.

A key challenge in generating simulated user utterances is having believable scenarios that are helpful for training the agent. The present technology uses both “typical” examples of expected user scenarios, to get good coverage of standard cases, as well as adversarial and boundary cases that test the agent's behavior at the margins. The scenarios may comprise different sets of factors, variables, and state data to test an automated agent's compliance with one or more controls.

Once the scenarios are generated, an automated agent and a simulated user are initiated with the scenarios and initial state data. The initial state data may include background information as to a simulated state that exists as the automated agent and simulated user begin their interaction. A conversation, exchange, or interaction between the automated agent and simulated user then occurs and is evaluated to determine if the controls were followed by the automated agent during the conversation. When an automated agent is determined to have properly followed a control during a conversation, the automated agent actions and conversation data is saved as a verified example and stored as training data. When an automated agent is determined to have not properly followed a control, the agent's actions and conversation data are stored in a failed pool, and the data not used as training data.

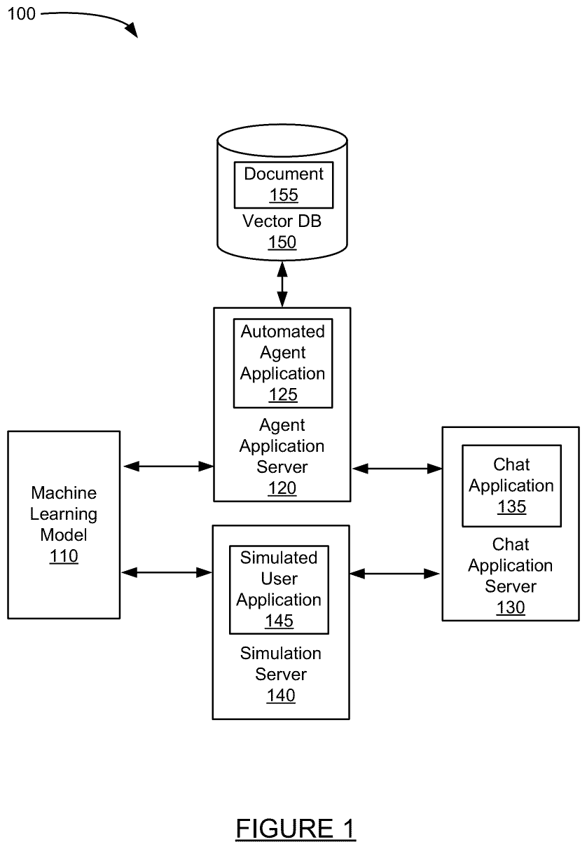

FIG. 1 is a system for providing an intelligent simulated user for generating training data. The system of FIG. 1 includes machine learning model 110, agent application server 120, chat application server 130, simulation server 140, and vector database 150.

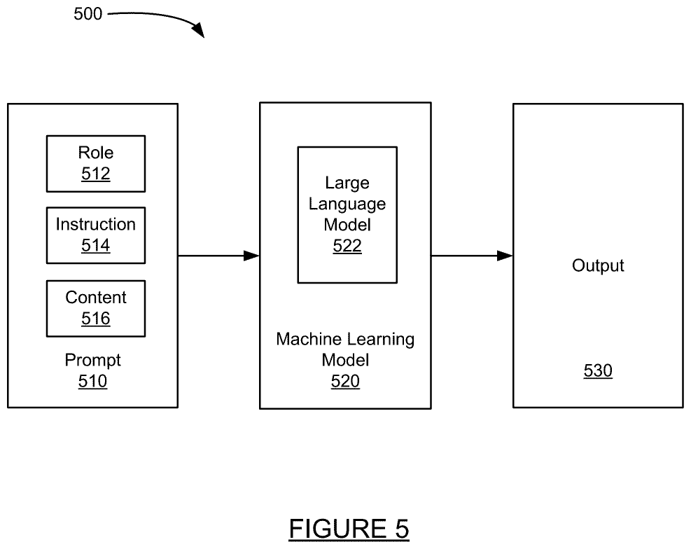

Machine learning model 110 may include one or more models or prediction engines that may receive an input, process the input, and predict an output based on the input. In some instances, machine learning model 110 may be implemented on agent application server 120, on the same physical or logical machine as automated agent application 125. In some instances, machine learning model 110 may be implemented by a large language model, on one or more servers external to agent application server 120. Implementing the machine learning model 110 as one or more large language models is discussed in more detail with respect to FIG. 5.

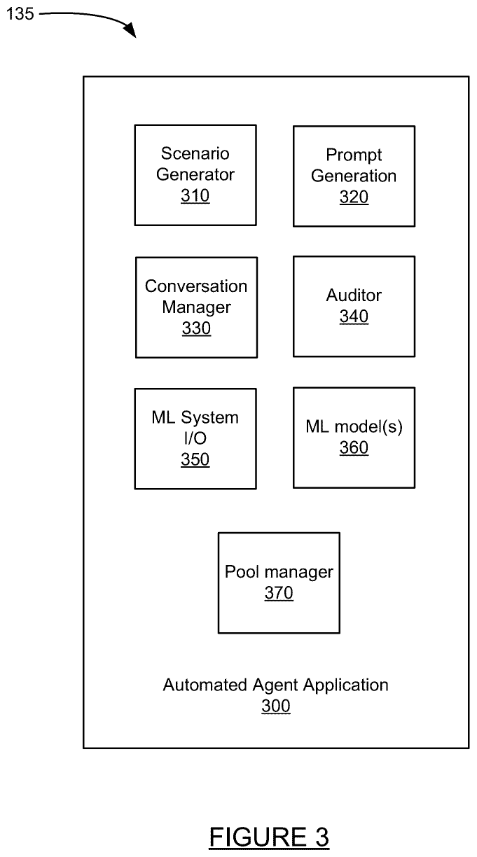

Agent application server 120 may include an automated agent application 125, and may communicate with machine learning model 110, chat application server 130, and vector database 150. Automated agent application 125 may be implemented on one or more servers 120, may be distributed over multiple servers and platforms, and may be implemented as one or more physical or logical servers. Automated agent application 125 may include several modules that implement the functionality described herein. More details for automated agent application 125 is discussed with respect to FIG. 3.

Chat application server 130 may communicate with agent application server 120, client device 140, and may implement a conversation and/or interaction over a network, such as for example a “chat,” between an automated agent application provided by agent application server 120 and a customer entity.

Simulation server 140 may be implemented as one or more physical or virtual machines logically separate from servers 120 and 130. Simulation server 140 may include simulated user application 145. Simulated user application 145 may initialize and manage the operation of a simulated user in a conversation with an automated agent through chat application 135. The simulated user application may submit requests, process responses, and otherwise communicate through chat application 135. The user application may conduct itself based on scenarios generated from one or more controls.

Vector database 150 may be implemented as a data store that stores vector data. In some instances, vector database 135 may be implemented as more than one data store, internal to system 103 and exterior to system 103. In some instances, a vector database can serve as an LLMs' long-term memory and expand an LLMs' knowledge base. Vector database 135 can store private data or domain-specific information outside the LLM as embeddings. When a user asks a question to an administrative assistant, the system can have the vector database search for the top results most relevant to the received question. Then, the results are combined with the original query to create a prompt that provides a comprehensive context for the LLM to generate more accurate answers. Vector database 150 may include data such as prompt templates, instructions, training data, and other data used by automated agent application 125 and machine learning model 110.

In some instances, the present system may include one or more additional data stores, in place of or in addition to vector database 150, at which the system stores searchable data such as instructions, private data, domain-specific data, and other data.

Each of model 110, servers 120-140, and vector database 150 may communicate over one or more networks. The networks may include one or more the Internet, an intranet, a local area network, a wide area network, a wireless network, Wi-Fi network, cellular network, or any other network over which data may be communicated.

In some instances, one or more of machines associated with 110, 120, 130 and 140 may be implemented in one or more cloud-based service providers, such as for example AWS by Amazon Inc, AZURE by Microsoft, GCP by Google, Inc., Kubernetes, or some other cloud based service provider.

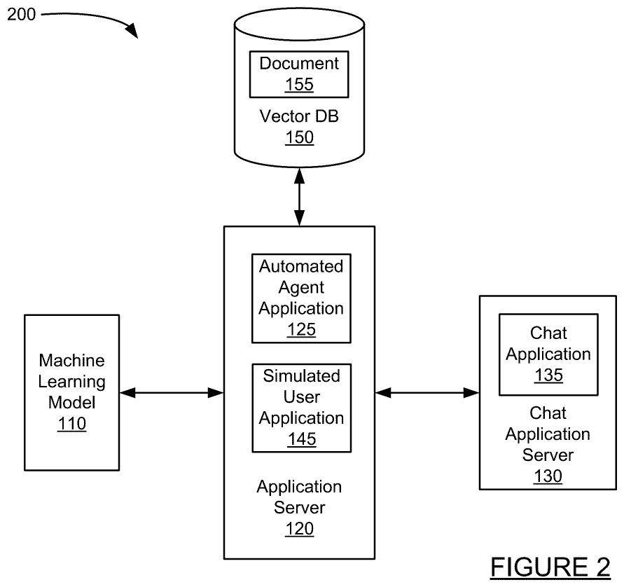

FIG. 2 is a system for providing another example of an intelligent simulated user for generating training data. The system of FIG. 2 includes machine learning model 110, application server 120, chat application server 130, and vector database 150. In some instances, the system of FIG. 2 is similar to system 100 of FIG. 1 except that simulated user application 145 is implemented on the same physical or logical server or servers as automated agent application 125.

FIG. 3 is a block diagram of an automated agent application. Automated agent application 300 provides more detail for application 135 of the system of FIGS. 1 and two. Automated agent application 300 includes scenario generator 310, prompt generation 320, conversation manager 330, auditor 340, machine learning system input and output module 350, machine learning models 360, and pool manager 370.

Scenario generator 310 may generate scenarios based on one or more controls. To generate the scenarios, scenario generator may provide input into a machine learning model or a large language model. For a large language model, the input may include a prompt which includes the role of the simulated user and/or automated agent, instructions, or controls from which the scenarios should be generated from, and other content. The scenario generator may provide the prompt to ML System I/O 350 to be processed by the particular model.

Prompt generation 220 may operate to generate a prompt to be fed into a large language model. A prompt may include one or more requests, role data associated with the role that the automated agent is to have during a conversation, a user inquiry, instructions retrieved based on the user inquiry, audit data, and optionally other data. The request may indicate what the large language model is requested to do, for example find relevant instructions, determine a next state from the current state, determine a response for a user inquiry, select a function or program to be executed, perform an audit of a predicted response, or some other goal. A role is a level of permission and authority that the automated agent has in a customer service capacity, such as a bottom level agent, a supervisor, a manager, or some other role. The instructions may include the rules, guidelines, and other guides for controlling what an automated agent can and cannot do when assisting a customer through a conversation or chat. Other data that may be included in a prompt, in addition to a request, role, and instructions, may include a series of actions not to do (e.g., a series of actions determined to be incorrect by an auditor).

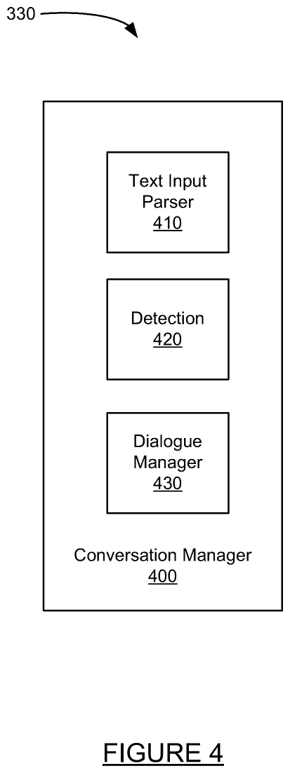

Conversation manager 230 may manage a conversation between an automated agent application 125 and client application 145. In some instances, conversation manager 250 may be implemented at least in part by an automated agent application 125. In some instances, conversation manager 250 may be implemented at least in part in chat application 125. The conversation manager may have capabilities such as parsing text input, detecting meaning within parsed text, and managing dialogue to and from a participant in the conversation. More details for conversation manager 250 are discussed with respect to the conversation manager of FIG. 4.

Auditor 240 may audit an actual or predicted response from an automated agent to a customer at client application 145. In some instances, auditor 340 may evaluate or audit whether an automated agent properly followed controls when processing a request from an actual or simulated user. In some instances, the auditor may access or create a checklist associated with a policy, and manage an evaluation of the automated agent in view of the list to determine if the automated agent properly followed the policy.

In some instances, the auditor may confirm if instructions followed by the automated agent were relevant, if the instructions were followed properly, and confirm other aspects related to generating a response to a customer inquiry.

Machine learning system I/O 250 may communicate with one or more machine learning models 110 280. ML system I/O 270 may provide prompts or input to and receive or retrieve outputs from machine learning models 110 and 280.

Machine learning (ML) model(s) 260 may include one or more machine learning models that generate predictions for state machines 210, and receive prompts, instructions, and requests to provide a response to particular inquiry, as well as perform other tasks. The machine learning models 260 can include one or more LLMs, as well as a combination of LLMs and ML models.

Pool manager 370 may manage pools of validated examples and unvalidated examples of automated agent actions. One or more validated examples of automated agent actions may be stored in a validated automated agent action pool, or validated pool. When an automated agent has followed controls properly while processing a request from a simulated user, conversation data and other data regarding the agent's actions are stored in the validated pool. Data in a validated pool is used as training data for subsequent instances of automated agents. When an automated agent is determined to have not followed controls when processing simulated user request, the automated agent actions and conversation data are stored in an unvalidated pool.

Modules illustrated in automated agent application 200 are exemplary, and could be implemented in additional or fewer modules. Automated agent application 200 is intended to at least implement functionality described herein. The design of specific modules, objects, programs, and platforms to implement the functionality is not specific and limited by the modules illustrated in FIG. 2.

FIG. 4 is a block diagram of a conversation manager. Conversation manager 400 provides more detail for conversation manager 350 of the block diagram of FIG. 3. Conversation manager 400 includes a text input parser 410, detection module 420, and dialogue manager 430. In some instances, conversation manager 400 may be implemented within chat application 125, automated agent application 135, or distributed between applications 125 and 135.

Text input parser 410 may parse text input provided by client to chat application 135. Detection 420 may analyze the parsed text to determine intent and meaning of the parsed text. Dialogue manager 430 may manage input received from client application 145 an automated agent application 125 into the conversation between them.

FIG. 5 is a block diagram of data flow for a machine learning model. The method of FIG. 5 includes prompt 510, machine learning model 520, and output 530.

Prompt 510 of FIG. 5 can be provided as input to a machine learning model 520. A prompt can include information or data such as a role 512, instructions 514, and content 516. The role indicates the authority level at which the automated agent is to assume while working to assist a user. For example, a role can include an entry-level customer service representative, a manager, a director, or some other customer service job with a particular level of permissions and rules that apply to what they can do and can't do when assisting a customer.

Instructions 514 can indicate what the machine learning model (e.g., a large language model) is supposed to do with the other content provided in the prompt. For example, the machine learning model instructions may request, via instructions 514, an LLM to select the most relevant instructions from content 230 to train or guide a customer service representative having a specified role 210, determine if a predicted response was generated with each instruction followed correctly, determine what function to execute, determine whether or not to transition to a new state within a state machine, and so forth. The instructions can be retrieved or accessed from document 155 of vector database 150.

Content 516 may include data and/or information that can help a ML model or LLM generate an output. For an ML model, the content can include a stream of data that is put in a processable format (for example, normalized) for the ML model to read. For an LLM, the content can include a user inquiry, retrieved instructions, policy data, checklist and/or checklist item data, programs and functions executed by a state machine, results of an audit or evaluation, and other content. In some instances, where only a portion of the content or a prompt will fit into an LLM input, the content and/or other portions of the prompt can be provided to an LLM can be submitted in multiple prompts.

Machine learning model 520 of FIG. 5 provides more detail for machine learning model 110 of FIG. 1. The ML model 520 may receive one or more inputs and provide an output. In some instances, the ML model may predict an output in the form of whether a policy was followed, whether a particular instruction is relevant, or some other prediction.

ML model 520 may be implemented by a large language model 522. A large language model is a machine learning model that uses deep learning algorithms to process and understand language. LLMs can have an encoder, a decoder, or both, and can encode positioning data to their input. In some instances, LLMs can be based on transformers, which have a neural network architecture, and have multiple layers of neural networks. An LLM can have an attention mechanism that allows them to focus selectively on parts of text. LLMs are trained with large amounts of data and can be used for different purposes.

The transformer model learns context and meaning by tracking relationships in sequential data. LLMs receive text as an input through a prompt and provide a response to one or more instructions. For example, an LLM can receive a prompt as an instruction to analyze data. The prompt can include a context (e.g., a role, such as ‘you are an agent’), a bulleted list of itemized instructions, and content to apply the instructions to.

In some instances, the present technology may use an LLM such as a BERT LLM, Falcon 30B on GitHub, Galactica by Meta, GPT-3 by OpenAI, or other LLM. In some instances, machine learning model 115 may be implemented by one or more other models or neural networks.

Output 530 is provided by machine learning model 520 in response to processing prompt 510 (e.g., an input). For example, when the prompt includes a request that the machine learning model identify the most relevant instructions from a set of content, the output will include a list of the most relevant instructions. In some instances, when the prompt includes a request that the machine learning model determine if an automated agent properly followed a set of instructions, a policy, or a checklist item during a conversation with a user, the machine learning model may return a confidence score, prediction, or other indication as to whether the instructions were followed correctly by the automated agent.

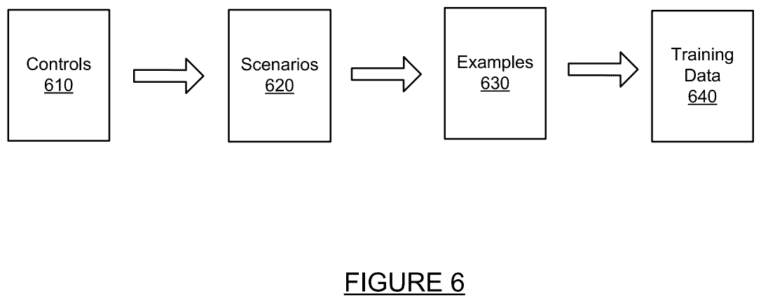

FIG. 6 illustrates how training data is generated from controls using the present system. FIG. 6 illustrates data of controls 610, scenarios 620, examples 630, and training data 640. Controls are accessed by the system based on rules or instructions that an automated agent should follow. Controls are then used to generate scenarios 620. A scenario is ace description, environment, or state data that is designed to test a particular control of control 610. One control may have several scenarios generated from it.

Scenarios are used to guide a simulated user in a conversation with an automated agent. The result of a conversation is multiple examples 630. The examples indicate how the automated agent interacted with and processed requests from a simulated user. For each example, if an automated agent properly followed controls associated with a scenario which resulted in the particular example, the example is determined to be validated and may be used as training data 640. If, for a particular example, an automated agent did not properly follow a control to process a simulated user request, and examples are put in a pool of bad examples and are not used as training data.

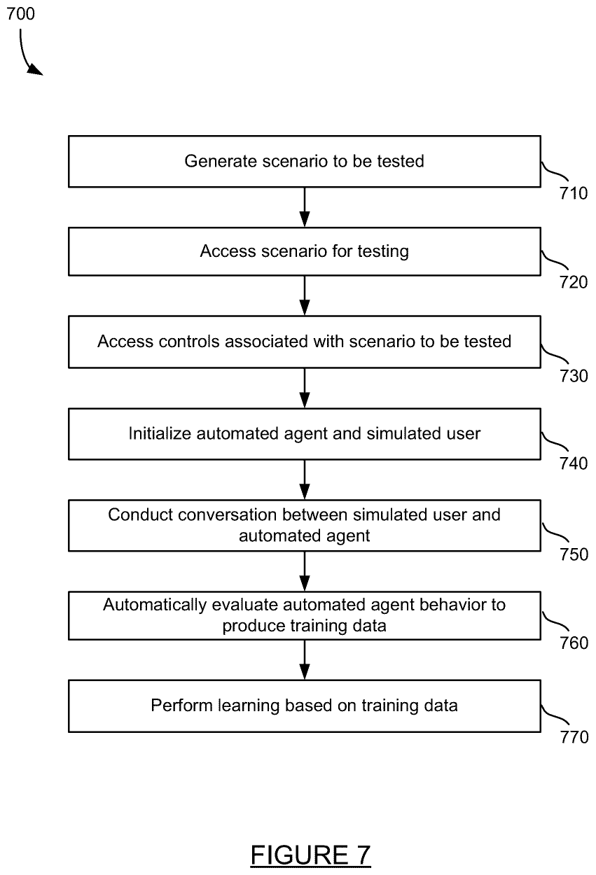

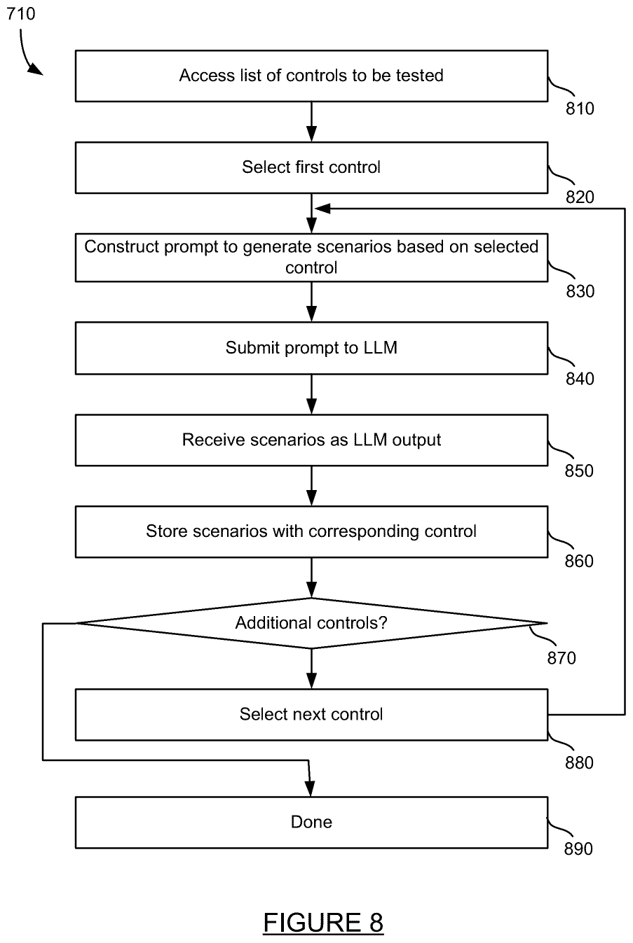

FIG. 7 is a method for intelligently generating training data using a simulated user. Scenarios to be tested are generated at step 710. Scenarios are generated based on controls that indicate rules and instructions to be followed by an automated agent during a conversation or interaction with a user or simulated user. Generating a scenario may include accessing controls, generating prompts, and having an LLM process the prompts for each of the controls. More details for generating a scenario to be tested are discussed with respect to the method of FIG. 8.

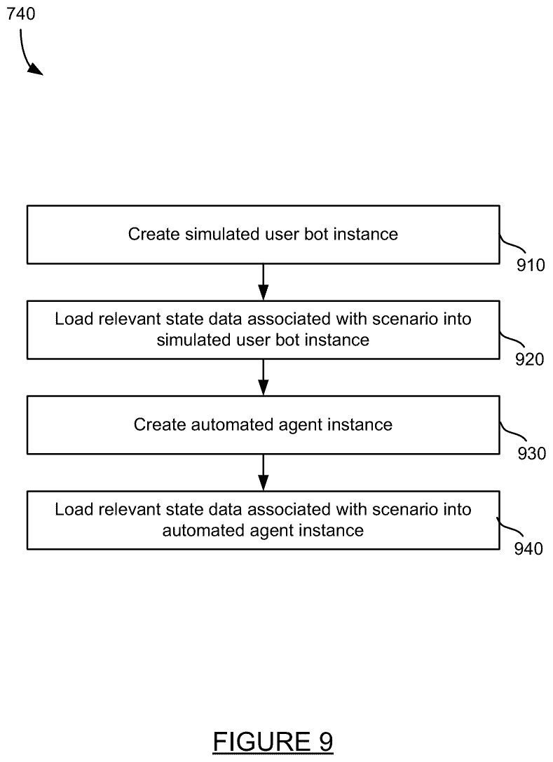

One or more scenarios may be accessed for testing at step 720. Controls associated with the particular scenario being tested are accessed at step 730. An automated agent and simulated user may then be initialized at step 740. Initializing a simulated user and an automated agent may include creating instances and instantiating relevant state data into the agent and user. More details for initializing an automated agent and simulated user is discussed with respect to the method of FIG. 9.

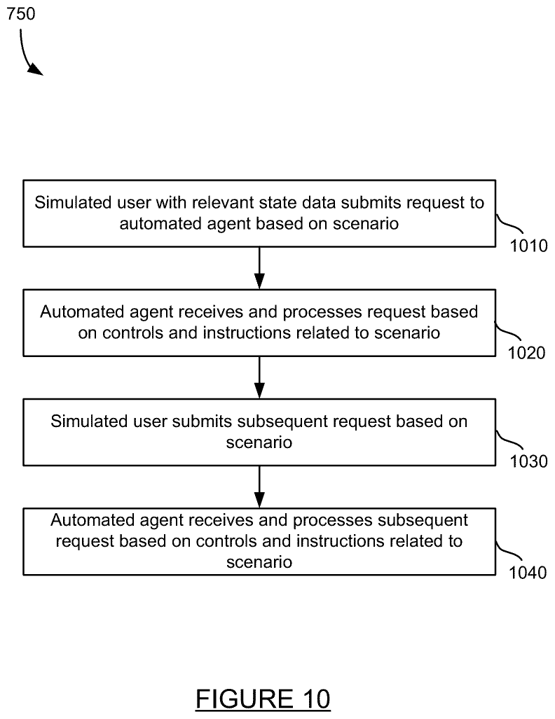

The automated agent and the simulated user conduct a conversation at step 750. The conversation is not between actual users, but rather between a simulated user that is submitting a request based on a particular scenario to the automated agent. Conducting a conversation between a simulated user and an automated agent is discussed in more detail with respect to the method of FIG. 10.

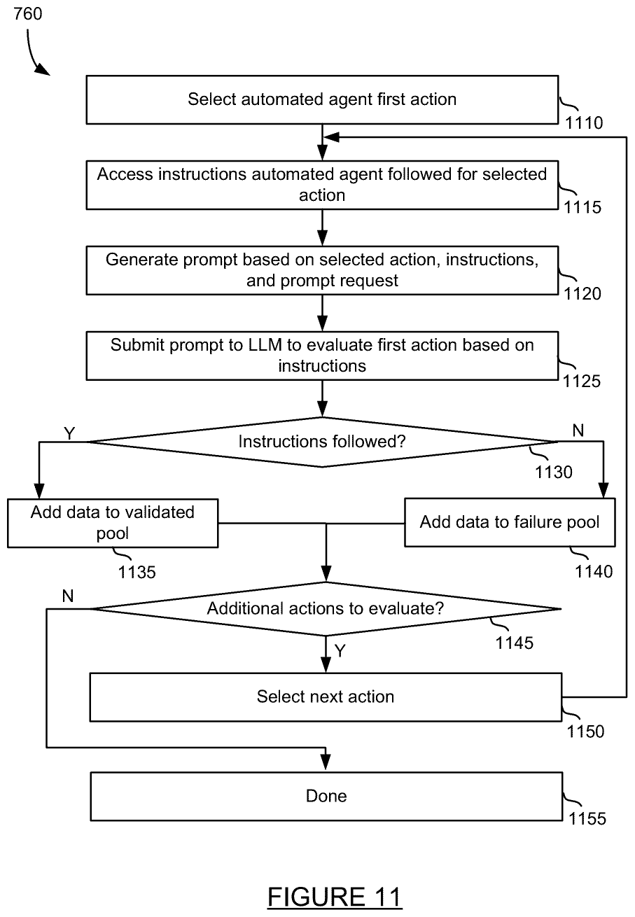

An automated agent's behavior is automatically evaluated to produce training data at step 760. Automatically evaluating the automated agent includes comparing the automated agent's actions to controls intended to be followed by the automated agent while processing simulated user requests. Automatically evaluating automated agent behavior is discussed in more detail with respect to the method of FIG. 11.

Machine learning model learning is then performed based on the training data at step 770. In some instances, in-context learning is performed using training data, wherein the training data is based on examples where the automated agent properly followed controls. In some instances, the training process includes reinforcement learning or supervised learning using training data based on data in the validated pool. With this learning, model weights may be fine-tuned based on the selected examples associated with validated automated agent responses.

FIG. 8 is a method for generating a scenario to be tested. The method of FIG. 8 provides more detail for step 710 the method of FIG. 7. A list of controls to be tested is accessed at step 810. The controls may relate to specific rules or policies, such as cancellation policies or refund policies to be followed by an automated agent. A first control in the list of controls is accessed at step 820.

A prompt is then constructed at step 830. The prompt is constructed to generate one or more scenarios. The present technology uses both “typical” types of expected user scenarios, to get good coverage of standard cases, as well as adversarial and boundary cases that test the agent's behavior at the margins. For typical scenarios, an administrator who manages an agent provides a text description of the general capabilities of the agent and a structured description of any state required by a scenario.

For example, for a hotel booking agent, the general description can include content indicating that the agent can make new bookings, update existing bookings, and search the web to find information related to hotels. The structured description can include information about existing hotel reservations that allows a user scenario to involve modifying the reservation, along with a mocked current date to use for the conversation. Given the general and structured descriptions, the present system uses a machine learning model, such as for example a large language model, to generate concrete scenarios that simulated users follow when interacting with the agent.

For adversarial and boundary cases, the present system can provide, or the administrator who manages an agent provides, a natural language description of a policy that should be tested. The generated scenarios in these cases include language and structured information that are targeted at probing the agent's behavior when the policy is relevant. For example, if the policy were a cancellation policy for a hotel, the scenario might include an existing reservation and a mocked date that is within the blackout window according to the cancellation policy, with a goal of trying to cancel the reservation in violation of the policy using whatever means necessary.

When constructing a prompt, the input may include a setting, such as a description of a typical or adversarial case discussed herein, may include instructions and/or controls, and may request an LLM to generate scenarios based in the setting and controls. The constructed prompt is then submitted to a large language model at step 840.

The large language model process the prompt and returns one or more scenarios that may be used to test the automated agent's adherence to the controls. The scenarios are received as LLM output at step 850. The scenarios may be stored with the corresponding control from which they are generated at step 860. A determination is then made as to whether there are any additional controls for which a scenario should be generated at step 870. If additional controls exist, the next control is selected at step 880 and the method of FIG. 8 returns to step 830. If there are no additional controls, the method of FIG. 8 ends at step 890.

FIG. 9 is a method for initializing an automated agent and simulated user. The method of FIG. 9 provides more detail for step 740 of the method of FIG. 7. A simulated user bot instance is created at step 910. Creating a simulated user bot instance may include executing programs and instantiating objects such that the user bot may operate and interact with a chat application.

Relevant state data may be loaded into the simulated user bot instance at step 920. The relevant state data may be associated with scenario information, such as for example reservations on file, the current date, names of hotels or airlines, reservation numbers, or other data.

An automated agent instance may be created at step 930. The relevant state data is loaded into the automated agent instance at step 940. The relevant state data may be associated with a scenario and will be similar to the state data loaded into a simulated user bot instance at step 920.

FIG. 10 is a method for conducting a conversation between a simulated user and an automated agent. The method of FIG. 10 provides more detail for step 750 of the method of FIG. 7. A simulated user with relevant state data submits a request to an automated agent based on a scenario at step 1010. After an initial message sent by the automated agent, the simulated user begins a conversation with a request to the automated agent. In some instances, the simulated user generates a request, or a response to an automated user response, using one or more machine language models. For example, data and/or information from a generated scenario may be submitted to a machine learning model, such as for example an LLM. The input to the LLM may include a prompt, which includes a role of the simulated user and/or the automated agent, instructions such as a control, the scenario associated with the control being tested in the current conversation, and a prompt request to return the action or request/response to be sent by the simulated user. The prompt or machine learning model input is submitted to the LLM or ML model, processed, and an output is provided. The output can then be communicated to the automated agent as a request, a response to an automated agent communication, or some other communication.

The automated agent receives and processes the simulated user request at step 1020. The automated agent may process the request based on controls and instructions related to the scenario which the simulated user is operating under. Once an automated agent receives and processes the request, and provides some response to the simulated user, a simulated user may generate and submit additional requests based on the current scenario at step 1030. In response, the automated agent may receive and process the subsequent requests at step 1040. As with step 1020, the automated agent processes subsequent requests based on controls and instructions related to the scenario at step 1040. The simulated user and automated agents may go back and forth any number of times until the processing of the particular scenario and simulated user requests are handled by the automated agent, or the automated agent indicates that it cannot process the simulated user requests.

FIG. 11 is a method for automatically evaluating automated agent behavior to produce training data. The method of FIG. 11 provides more detail for step 760 of the method of FIG. 7. An automated agent's first action is selected at step 1110. The first action is one of several actions performed by the automated agent during a conversation with the simulated user based on the scenario followed by the simulated user. Instructions that the automated agent followed for the selected action are accessed at step 1115. The instructions may be equivalent to or similar to the controls for which a scenario is generated in order to guide the simulated user for the particular conversation.

A prompt is then generated at step 1120. The prompt is based on a selected action, instructions, and a prompt request. The generated prompt is then submitted to a large language model at step 1125. The prompt is designed to get the large language model to evaluate the first action based on the instructions. The large language model receives and process the prompt, and then provides a response or output. The output is received by the present system, and a determination is made as to whether instructions were followed by the automated agent at step 1130. If instructions were not followed when the automated agent processed the controls to handle the simulated user request, the conversation data and automated agent response is added to an unvalidated pool at step 1140. Conversation data and action data by an agent where instructions were not followed will not be used as training data. The method of FIG. 11 then continues to step 1145.

If instructions were followed at step 1130, the agent's conversation data and response data is added to a validated pool at step 1135. Examples in the validated pool can be used as training data for subsequent training of automated agents. The method of FIG. 11 then continues to step 1145.

A determination is made as whether additional actions exist to be evaluated at step 1145. If additional actions exist, the next action is selected at step 1150 and the method continues to step 1115 if no additional actions exist to be evaluated, the method of FIG. 11 is done at step 1155.

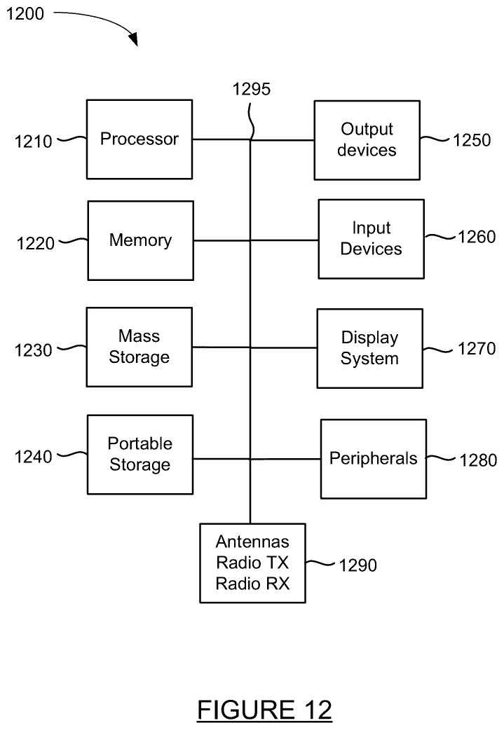

FIG. 12 is a block diagram of a computing environment for implementing the present technology. System 1200 of FIG. 12 may be implemented in the contexts of the likes of machines that implement machine learning model 110, application server 120, chat application server 130, and simulation server 140. The computing system 1200 of FIG. 12 includes one or more processors 1210 and memory 1220. Main memory 1220 stores, in part, instructions and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1295. However, the components may be connected through one or more data transport means. For example, processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive, an optical disk drive, a flash drive, or other device, is a non-volatile storage device for storing data and instructions for use by processor unit 1210. Mass storage device 1230 can store the system software for implementing embodiments of the present invention for purposes of loading that software into main memory 1220.

Portable storage device 1240 operates in conjunction with a portable non-volatile storage medium, such as a floppy disk, compact disk or Digital video disc, USB drive, memory card or stick, or other portable or removable memory, to input and output data and code to and from the computer system 1200 of FIG. 12. The system software for implementing embodiments of the present invention may be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1200 as shown in FIG. 12 includes output devices 1250. Examples of suitable output devices include speakers, printers, network interfaces, and monitors.

Display system 1270 may include a liquid crystal display (LCD) or other suitable display device. Display system 1270 receives textual and graphical information and processes the information for output to the display device. Display system 1270 may also receive input as a touch-screen.

Peripherals 1280 may include any type of computer support device to add additional functionality to the computer system. For example, peripheral device(s) 1280 may include a modem or a router, printer, and other device.

The system of 1200 may also include, in some implementations, antennas, radio transmitters and radio receivers 1290. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1200 of FIG. 12 are those typically found in computer systems that may be suitable for use with embodiments of the present invention and are intended to represent a broad category of such computer components that are well known in the art. Thus, the computer system 1200 of FIG. 12 can be a personal computer, handheld computing device, smart phone, mobile computing device, tablet computer, workstation, server, minicomputer, mainframe computer, or any other computing device. The computer can also include different bus configurations, networked platforms, multi-processor platforms, etc. The computing device can be used to implement applications, virtual machines, computing nodes, and other computing units in different network computing platforms, including but not limited to AZURE by Microsoft Corporation, Google Cloud Platform (GCP) by Google Inc., AWS by Amazon Inc., IBM Cloud by IBM Inc., and other platforms, in different containers, virtual machines, and other software. Various operating systems can be used including UNIX, LINUX, WINDOWS, MACINTOSH OS, CHROME OS, IOS, ANDROID, as well as languages including Python, PHP, Java, Ruby, .NET, C, C++, Node.JS, SQL, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for generating training data using a simulated user, comprising:
generating one or more scenarios by a first application on a first server based on a control;
providing a simulated user based on the scenario, the simulated user provided by a simulated user application;
accessing an example of an interaction between an automated agent and the simulated users by the first application, wherein each example is associated with an action by the automated agent, wherein the action is associated with the control, wherein the example including a subset of the interaction; and
selecting the example as training data for a subsequent learning process based on whether the automated agent action in the example is validated to be proper based on the control.

2. The method of claim 1, wherein a scenario includes one or more parameters set to test whether the automated agent follows the control in response to a simulated user request.

3. The method of claim 1, wherein a scenario is generated by a large language model in response to a prompt provided to the large language model, the prompt including the control, the role of the automated agent, and a prompt request to generate one or more scenarios based on the control and role.

4. The method of claim 1, further comprising evaluating whether the automated agent followed the control when responding to a simulated user request, the simulated user request generated based on the scenario.

5. The method of claim 1, wherein evaluating includes processing interaction data and the control by a machine learning model.

6. The method of claim 5, wherein the machine learning model includes a large language model.

7. The method of claim 1, wherein the automated agent action is evaluated during the conversation with the simulated user.

8. The method of claim 1, wherein the example is stored as training data in a validated pool.

9. A non-transitory computer readable storage medium having embodied thereon a program, the program being executable by a processor to generate training data using a simulated user, the method comprising:
generating one or more scenarios by a first application on a first server based on a control;
providing a simulated user based on the scenario, the simulated user provided by a simulated user application;
accessing an example of an interaction between an automated agent and the simulated users by the first application, wherein each example is associated with an action by the automated agent, wherein the action is associated with the control, wherein the example including a subset of the interaction; and
selecting the example as training data for a subsequent learning process based on whether the automated agent action in the example is validated to be proper based on the control.

10. The non-transitory computer readable storage medium of claim 9, wherein a scenario includes one or more parameters set to test whether the automated agent follows the control in response to a simulated user request.

11. The non-transitory computer readable storage medium of claim 9, wherein a scenario is generated by a large language model in response to a prompt provided to the large language model, the prompt including the control, the role of the automated agent, and a prompt request to generate one or more scenarios based on the control and role.

12. The non-transitory computer readable storage medium of claim 9, further comprising evaluating whether the automated agent followed the control when responding to a simulated user request, the simulated user request generated based on the scenario.

13. The non-transitory computer readable storage medium of claim 9, wherein evaluating includes processing interaction data and the control by a machine learning model.

14. The non-transitory computer readable storage medium of claim 13, wherein the machine learning model includes a large language model.

15. The non-transitory computer readable storage medium of claim 9, wherein the automated agent action is evaluated during the conversation with the simulated user.

16. The non-transitory computer readable storage medium of claim 9, wherein the example is stored as training data in a validated pool.

17. A system for generating training data using a simulated user, comprising:
one or more servers, wherein each server includes a memory and a processor; and
one or more modules stored in the memory and executed by at least one of the one or more processors to generate one or more scenarios by a first application on a first server based on a control, provide a simulated user based on the scenario, the simulated user provided by a simulated user application, access an example of an interaction between an automated agent and the simulated users by the first application, wherein each example is associated with an action by the automated agent, wherein the action is associated with the control, wherein the example including a subset of the interaction, and select the example as training data for a subsequent learning process based on whether the automated agent action in the example is validated to be proper based on the control.

18. The system of claim 17, wherein a scenario includes one or more parameters set to test whether the automated agent follows the control in response to a simulated user request.

19. The system of claim 17, wherein a scenario is generated by a large language model in response to a prompt provided to the large language model, the prompt including the control, the role of the automated agent, and a prompt request to generate one or more scenarios based on the control and role.

20. The system of claim 17, further comprising evaluating whether the automated agent followed the control when responding to a simulated user request, the simulated user request generated based on the scenario.
